(19) United States
(12) Patent Application Publication
(10) Pub. No.: US 2024/0296687 A1
(43) Pub. Date: Sep. 5, 2024

(54) EXCEPTION HANDLING USING INSTANT OPTICAL CHARACTER RECOGNITION

(71) Applicant: Capital One Services, LLC, McLean, VA (US)

(72) Inventors: Keegan FRANKLIN, Tucson, AZ (US); Carlos GRASSO, Richmond, VA (US); Suranya Jayan SCHOTT, Vienna, VA (US); James BRIGHTER, Reston, VA (US); Thomas R. KUKLINSKI, Swarthmore, PA (US)

(73) Assignee: Capital One Services, LLC, McLean, VA (US)

(21) Appl. No.: 18/116,552

(22) Filed: Mar. 2, 2023

(51) Int. Cl. G06V 30/18; G06Q 20/10; G06Q 20/38; G06V 30/19; G06V 30/40

(52) U.S. Cl. CPC G06V 30/18; G06Q 20/108; G06Q 20/389; G06V 30/19147; G06V 30/1916; G06V 30/40

(57) ABSTRACT

Systems for detecting and resolving exceptions during a document upload process are disclosed. The system can receive, via a document upload application installed on user equipment, a document to be uploaded to a user account maintained by the system. An OCR component may be used to detect exceptions associated with the document and the system may include a component to handle any detected exceptions to prevent termination of the document upload process.

### TECHNICAL FIELD

Aspects relate to systems and methods for implementing exception handling routines as part of performing instant optical character recognition (OCR) of documents to be uploaded to a backend system during a document upload process.

### BACKGROUND

Currently, computer-based (e.g., laptop) or mobile-based (e.g., mobile device) technology allows a user to upload images or other electronic versions of a document to a backend system (e.g., a document processing system) for various purposes, e.g., remote deposit of a check, obtaining approval for a credit card, or updating user account information. Documents may include information that is used by a backend system at, for example, a bank. This information may include user information related to the user initiating the upload, account information related to the account to which the document is being uploaded, and content information related to content that is detected in the document. In some cases, certain exceptions may occur during the document upload process, i.e., while the document is being uploaded and processed by the backend system. Examples of such exceptions include issues with the image or images of the document being uploaded or user-specific error conditions associated with content stored on the document. As one example, a check that a user attempts to upload utilizing a mobile deposit application may be ineligible.

Current document upload processes have limited, if any, capability to handle such exceptions. That is, when any exception is detected during the upload, current upload processes may automatically and immediately be terminated, preventing the upload from occurring, without providing any exception or error handling options for addressing the detected error. The user is then forced to retry the upload attempt.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the pertinent art to make and use the disclosure.

FIG. 1 is an exemplary document upload environment for providing exception handling during a document upload process according to aspects of the present disclosure.

FIG. 2A is an example flowchart of a document upload process that includes performing a limits exception procedure according to aspects of the present disclosure.

FIG. 2B is an example flowchart of a document upload process that includes performing a secondary review of documents according to aspects of the present disclosure.

FIG. 3 is a block diagram of a machine learning system for training a limits model and use of the limits model during an upload process, according to some embodiments.

FIG. 4 is an example computer system useful for implementing various embodiments.

In the drawings, like reference numbers generally indicate identical or similar elements. Additionally, generally, the leftmost digit(s) of a reference number identifies the drawing in which the reference number first appears.

### DETAILED DESCRIPTION

The following aspects are described in sufficient detail to enable those skilled in the art to make and use the disclosure. It is to be understood that other aspects are evident based on the present disclosure, and that system, process, or mechanical changes may be made without departing from the scope of an aspect of the present disclosure.

In the following description, numerous specific details are given to provide a thorough understanding of aspects. However, it will be apparent that aspects may be practiced without these specific details. To avoid obscuring an aspect, some well-known circuits, system configurations, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the system may be operated in any orientation.

Certain aspects have other steps or elements in addition to or in place of those mentioned. The steps or elements will become apparent to those skilled in the art from a reading of the following detailed description when taken with reference to the accompanying drawings.

### System Overview and Function

Provided herein are system, apparatus, device, method and/or computer program product embodiments, and/or combinations and sub-combinations thereof for providing exception handling during a document upload process. Exceptions are error conditions that may occur during an upload process to a backend system. These error conditions may be defined by a backend system that manages the document upload process and may include, for example, deviations of the document from a standardized format (determined based on the document type), such as missing expected fields such as account numbers, routing numbers, user information, and other text, and detected content in the document being greater than a threshold value that is allowed for the user account to which the document is being uploaded. Exception handling in the present disclosure may be actions that are triggered upon detection of detected error(s) for the purpose of mitigating risks to the backend system.

In some embodiments, the technology described herein implements a system that performs optical character recognition (OCR) during a document upload process in order to detect any exceptions related to the document being uploaded, such as an error in the document image to be uploaded, risk conditions associated with the document (or content within the document), and/or risk conditions associated with the user. In some embodiments, the technology disclosed herein provides a workflow that includes instant OCR of document images taken by a document upload application and that are uploaded to a backend system to update a user account. The term “instant OCR” may refer to an OCR process that is initiated automatically at the backend system without user input and, in some instances, automatically upon the backend system receiving images of the document to be uploaded. In a non-limiting example, the technology disclosed herein triggers transmission, from a document upload application to the backend system, of document images upon receiving one of a first document image or a second document image. The technology described herein improves the technology associated with uploading documents by preemptively performing certain steps of the document upload process without having to wait for a user's instruction(s).

Upon detecting an error condition, the system may initiate an exception handling process for mitigating the detected error condition without immediately and automatically terminating the upload process. In a non-limiting example, an error condition may be any error associated with the uploaded document images such as improper alignment of the document within the image, unreadable content within the document image, and unexpected or missing parameters within the document. In another non-limiting example, an error condition may include a risk condition associate with content in the document and/or the user account to which the document is being uploaded. The risk condition may indicate that content in the document is greater than a threshold amount that is set for the particular document type, the user who initiated the upload, or both. In some embodiments, the risk condition may indicate irregularities in the document, which could be a result of errors in the uploaded images or missing expected data within the documents. A risk condition may be based on reviewing a history of actions of the user account such as prior upload attempts and account activity and history. In the context of a mobile check deposit, the content detected in a check may identify a monetary value to be deposited in the user's bank account and a routing number that is associated with an issuing bank for that check. The user account may be the user's bank account (e.g., checking or savings) into which the monetary amount specified by the check are to be deposited and the threshold amount may be the check deposit limit. Content associated with the document may include the monetary amount to be deposited to the user account, the issuing bank, the routing number, and the account number.

In some embodiments, the technology disclosed herein provides a framework that utilizes a machine learning model to detect risk conditions associated with the document and/or the user during the document upload process. The model may generate a confidence score indicating the level of risk associated with uploading the particular document. In a non-limiting example, to generate the confidence score, the model may utilize a number of different input parameters such as the content detected within the document and user information associated with the user who initiated the upload process. A machine learning engine may be utilized to train the machine learning model for improving the accuracy of the confidence score. In a non-limiting example, the technology disclosed herein provides a machine learning model for identifying an amount limit that can be deposited to a user's bank account which is used as the threshold value for the monetary amount to be deposited by a check. If the monetary amount is greater than this threshold value, then the model may perform a second determination whether to approve the upload. This second determination may be based on the confidence score being above a second threshold value that represents the amount of risk in allowing the upload to proceed. The machine learning model may be used to dynamically identify an amount limit for each user based on the parameters discussed above, the user information and the extracted content from the document to be uploaded. The technology described herein improves the technology associated with processing document uploads by, at a minimum, properly identifying exception conditions during the upload and providing mechanisms for addressing the exceptions without terminating the upload.

In some embodiments, the technology disclosed herein provides exception handling mechanisms during the upload process. These mechanisms include implementing a secondary review process for reviewing the error conditions and providing corrective actions to address the error conditions. In a non-limiting example, the error condition may be an error in the document image and the corrective action may include rerouting the process to a second eye system for confirming and correcting the detected error. In a non-limiting example, the error condition may be unexpected parameters (e.g., missing or extra content in the document) detected in the document and the corrective action may be a second eye review of the document to verify the validity of the unexpected parameters.

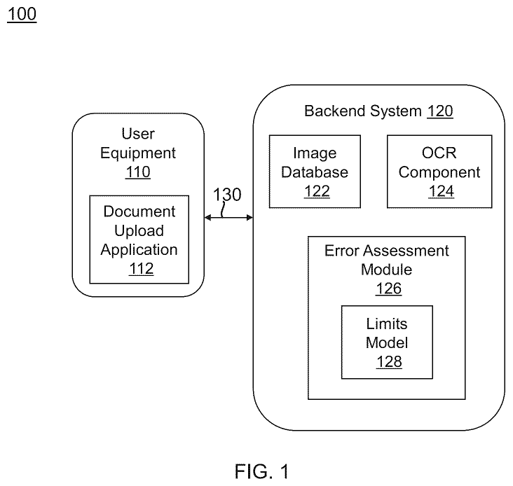

Therefore, the technology described herein solves one or more technical problems that exist in the realm of online computer systems and in particular, with automated document upload processes that typically lack mechanisms for handling exceptions, or error conditions. This problem is rooted in the typical network communications between a document upload application installed on a user equipment and a backend system where errors may occur within these network communications during a document upload process. This problem prevents such backend systems from efficiently processing document upload requests. In backend systems that processes millions of such requests, the effect of inefficiencies accumulate quickly. The technology as described herein provides an improvement to such systems and their ability to handle errors during a document upload. Therefore, one or more solutions described herein are necessarily rooted in computer technology through the modification of communications between the document upload application and the backend system to accurately identify errors of a document upload process and address those identified errors. The technology described herein reduces or eliminates the problem of conventional document upload processes as will be described in the various embodiments of FIGS. 1-4.

Various embodiments of these features will now be discussed with respect to the corresponding figures.

FIG. 1 is an exemplary document upload environment 100 for providing exception handling capability to a document upload process according to aspects of the present disclosure. In one example, environment 100 comprises user equipment 110 and backend system 120. Exception handling may be implemented to provide risk control for communications between user equipment 110 and backend system 120. Risk control is a strategy that aims to identify, assess, and prepare for any dangers, hazards, errors, and other potentials for loss or exposure that may interfere with operations and objectives of backend system 120. As illustrated, backend system 120 may, in some embodiments, include an error assessment module 126 to manage errors detected based on security rules during a document upload process.

User equipment 110 may be a desktop, workstation, laptop, notebook computer, digital assistant, netbook, tablet, smart phone, mobile phone, smart watch or other wearable, appliance, part of the Internet-of-Things, and/or embedded system, to name a few non-limiting examples, or any combination thereof. User equipment 110 may allow a user to perform a variety of tasks that include accessing, running, or otherwise interacting with applications. In one embodiment, user equipment 110 may include a document upload application 112 that allows documents to be uploaded to backend system 120. The backend system 120 may include an image database 122, an OCR component 124, and an error assessment module 126, which may further include a limits model 128. User equipment 110 may be connected to backend system 120 through a network connection 130 that can be implemented via a wireless communication network, a wireline communication network, and/or any combination thereof that will be apparent to those skilled in the relevant art(s) without departing from the spirit and scope of the present disclosure. In embodiments, the network connection 130 between user equipment 110 and backend system 120 may be implemented via a LAN, WAN, PAN, VPN, or other network and may include the Internet. The network connection 130 may also be a connection via a cloud-based network. In some embodiments, communications between user equipment 110 and backend system 120 are encrypted and transferred over the network connection 130 which is secured.

Document upload application 112 may be configured to display a graphical user interface on a display of user equipment 110. The graphical user interface may provide an interface for receiving and capturing images of documents to be uploaded to backend system 120. Document upload application 112 may include a camera function that utilizes a camera (not shown) of user equipment 110 to capture one or more images of a document to be uploaded to the backend system 120. However, any image capture device (e.g., a scanner) may be used as would be apparent to a person having ordinary skill in the art.

In a conventional upload process, any exceptions detected by the conventional upload application or by a conventional backend system would result in terminating the upload process and forcing the user to submit a subsequent upload request. For example, the conventional backend system might request that the user capture the image a second time. Alternatively, exceptions detected in any uploaded images or exceptions based on specific conditions associated with the document and/or the user may cause a conventional backend system to terminate the upload process and prevent the document from being uploaded.

As previously noted, techniques of the present disclosure provide a number of improvements over this conventional upload process. Instead of terminating the document upload process, error assessment module 126 may communicate with document upload application 112 to provide exception handling routines for different errors that are detected during an upload process via an instant OCR routine. For example, to address an error related to image errors (e.g., smudges, unreadable text) detected by OCR component 124, error assessment module 126 may initiate a routine that includes triggering a prompt at document upload application 112, receiving a user response indicating whether to initiate a secondary review of uploaded images via document upload application 112 in response to the prompt, and then initiating the secondary review of any upload images in coordination with the document upload application 112. In some embodiments, the secondary review may be triggered automatically without requiring a user response. Automatic triggers may be based on the error type or the number of errors detected in the uploaded images. As another example, if the error relates to differences in the document to a standard or expected format as determined by the document type of the document, the secondary review may be initiated to verify the validity of the document based on the differences. As another example, to address an exception involving upload limits associated with a user (e.g., maximum limit amount for a check), error assessment module 126 may utilize limits model 128 to determine whether to dynamically approve an override of the limits amount for the document and allow the upload process to proceed.

In some embodiments, document upload application 112 may be configured with separate application programming interface (API) calls for initiating different aspects of the document upload process. For example, document upload application 112 may include an OCR API call that is triggered upon receiving one or more document images by document upload application 112 and an Exception Handling API call that is triggered upon receiving a signal from error assessment module 126.

For the OCR API call, document upload application 112 may capture a first image of a document, such as the first page or the front of the document, and a second image of the document, such as additional pages or the back of the document. Document upload application 112 may be configured to trigger an OCR API call immediately upon capturing the first image or wait for subsequent images such as the second image to be captured. Document upload application 112 may be further configured to modify one or more of the document images to include an OCR request tag as part of the OCR API call. Backend system 120 may be configured to detect the OCR request tag and, upon detection, transmit the document images to OCR component 124.

In some embodiments, OCR component 124 receives the document images transmitted from document upload application 112, performs OCR on the document images, and may pass results of the OCR process to error assessment module 126 and/or limits model 128. OCR component 124 may detect content of the document that may be used for further processing. In an embodiment involving a check to be deposited into a user's account, OCR component 124 may detect the monetary value, the routing number of the issuing bank, and the account number identifying the account where the money for the check will be withdrawn. In other embodiments, the uploaded document may be an application for opening the account or for applying for a financial instrument, such as a credit card or a debit card or user identification such as a driver's license. Such documents may have standardized formats and fields and expected information in each field such as name and address. OCR component 124 may be used to detect the information in the fields of the document.

In some embodiments, the document upload process may include additional processing steps after backend system 120 receives the document image(s) from the document upload application 112 and performs OCR on the document images. Examples of additional processing include performing actions associated with the document such as storing the document in a storage location and executing the exception handling routines based on any detected exceptions in the document.

For the Exception Handling API call, document upload application 112 may receive a signal from error assessment module 126 that indicates an error has been detected during the upload process. In some embodiments, the signal may include information about the error and actions that may be taken by the document upload application 112. For example, the action may cause a prompt to be displayed by document upload application 112. The prompt may enable input from the user of the document upload application 112 to trigger secondary review of the document upload. In some embodiments, the signal may include information about the results of an error mitigation process at the backend system 120 and any instructions associated with continuing or terminating the upload process in response to the results of the error mitigation process. In some embodiments, the signal may include a notification with the results of the limits approval.

In some embodiments, backend system 120 may be implemented as a variety of centralized or decentralized computing devices. For example, backend system 120 may be implemented as one or more servers, grid-computing resources, a virtualized computing resource, cloud computing resources, peer-to-peer distributed computing devices, a server farm, or a combination thereof. Backend system 120 may be centralized in a single device, distributed across multiple devices within a cloud network, distributed across different geographic locations, or embedded within a network. Backend system 120 can communicate with other devices, such as a user equipment 110. Components of backend system 120, such as image database 122, an OCR component 124, and error assessment module 126 may be implemented within the same device (such as when backend system 120 is implemented as a single device) or as separate devices (such as when backend system 120 is implemented as a distributed system with components connected via a network).

Image database 122 may be implemented as a network storage resource (e.g., Amazon S3®, Storage Area Network (SAN), Network File System (NFS), etc.) and configured to store uploaded document images received from document upload applications.

OCR component 124 may be implemented as a module that employs optical character recognition technology to detect content in images of documents being uploaded to backend system 120.

Error assessment module 126 may be implemented as a computing device that detects any errors associated with the document during the document upload process. In some embodiments, this error assessment may be based on a signal from OCR component 124 indicating an error in the images uploaded to image database 122 during the current upload process. In some embodiments, the signal from the OCR component 124 may indicate the content of the document is missing expected parameters or has unknown parameters compared to a standard format based on the document type of the document. For example, a check may have a standard format specifying the routing number and account number and a document that is missing one of these parameters may be identified as an exception, triggering the secondary review.

In some embodiments, this error assessment may be based on transmitting the detected content by the OCR component 124 as inputs to limits model 128, which may be implemented as a machine learning model trained for risk detection of documents to be uploaded to user accounts associated with backend system 120. That is, given a particular document and its document content, limits model 128 is trained to determine the presence of risk involved with allowing the document to be uploaded to the user account. In embodiments where the document is a check, limits model 128 may be trained to generate the risk assessment based on the user account into which the check is to be deposited and the check contents such as the check amount, the account number, and the routing number. When the detected check amount is larger than the preset threshold amount (e.g., defined by a user-specific rule), the risk assessment may reflect a confidence score as to whether to approve the upload for the detected check amount. Certain factors may increase the risk such as the difference between the check amount and the preset threshold amount, the identity of the issuing bank as identified by the routing number, and historical activity of the user associated with the account. For example, a check amount that is well above a certain threshold may raise the risk, the bank indicated by the routing number may be less reputable (e.g., based on a reputation ranking of known banks), and a newer user account may be at higher risk because of the lack of activity history and trend information for that user account. One or more of these factors may be considered as part of generating the confidence score for the upload. Once generated, error assessment module 126 may compare the confidence score with a threshold value to determine whether to approve or deny the upload. In additional embodiments, the approval of the upload by error assessment module 126 may be a one-time approval (e.g., for the current upload request), a time-based approval (e.g., for a specific time period such as a week), and/or may be tied to the particular user (e.g., so that future upload requests from the user may be automatically approved).

As noted, the output of limits model 128 may be a confidence score representing a level of risk for approving the upload for a document when contents of the document are determined to be above a preset confidence level threshold. The confidence level threshold represents an acceptable risk level associated with a user or group of users and may be set by error assessment module 126. Increasing the confidence level threshold increases the acceptable level of risk associated with approving the upload request. That is, the confidence level threshold is inversely proportional to the acceptable risk level where the higher the confidence level threshold, the lower the risk to backend system 120 in approving the upload request (e.g., to allow the document to be uploaded despite specifying a monetary amount greater than the threshold amount). Error assessment module 126 may utilize the output to make a decision regarding whether to continue the upload process. Inputs to the limits model 128 may include information detected by OCR component 124 and user information of the user initiating the upload. In some embodiments, information detected by OCR component 124 may be used to retrieve additional information for use as input to the limits model 128. For example, OCR component 124 may provide routing information detected on a check and error assessment module 126 may use the routing information to retrieve the issuing bank of the check based on the routing number, which may then be used as an additional input to the limits model 128 for generating the confidence score.

The modules described in FIG. 1 may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the environment 100 or installed as a removable portion of the environment 100.

Environment 100 can be used in a variety of areas implementing document upload techniques. These include financial applications, security applications, etc. where documents being uploaded into user accounts may be subject to fraudulent activity. For example, when processing important document such as driver's licenses, checks, financial documents, etc. The environment 100 allows for determined risk associated with these documents and user accounts to be preemptively calculated prior to completion of the document upload process and also allows for security steps to be taken to increase the security of the document upload process prior to completion of the upload.

### Methods of Operation

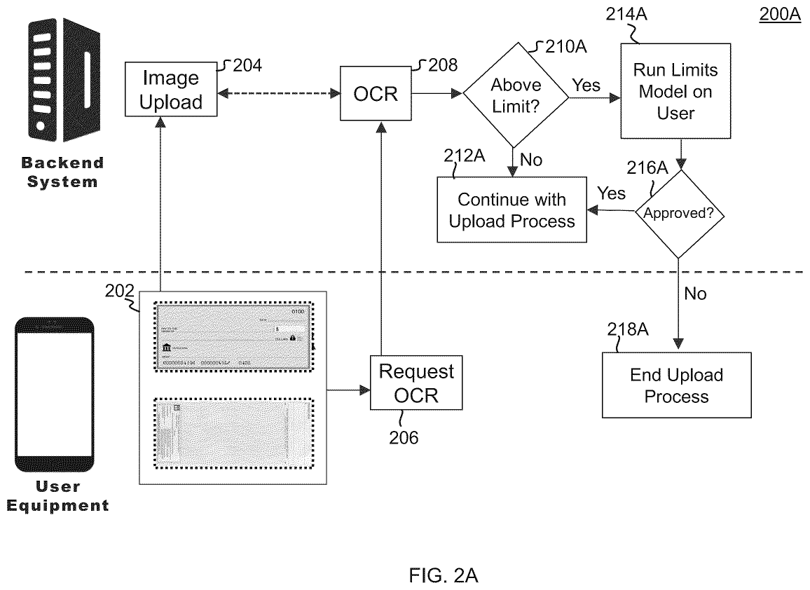

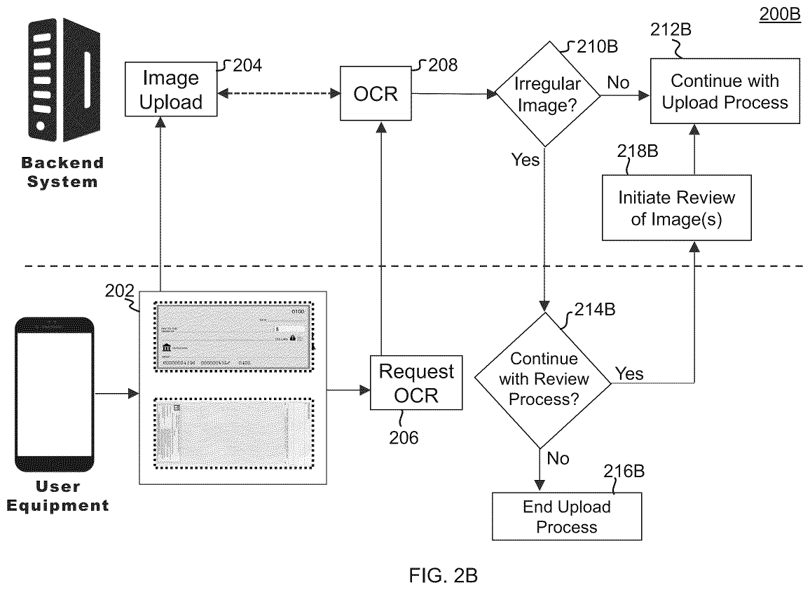

FIGS. 2A and 2B are example methods of operating the environment 100 to perform instant OCR of document images to be uploaded to a user account and provide exception handling capability for errors occurring during the upload process, according to aspects of the present disclosure.

FIG. 2A is an example method 200A for handling errors associated with limits related to the uploaded document. As a non-limiting example with regards to FIG. 1, one or more processes described with respect to FIG. 2A may be performed by one or more devices of environment 100. In such an embodiment, the one or more devices of environment 100 may execute code in memory to perform certain steps of method 200A. While method 200A of FIG. 2A will be discussed below as being performed by one or more components of environment 100, other devices not shown may store the code and therefore may execute method 200A by directly executing the code. Accordingly, the following discussion of method 200A will refer to devices of FIG. 1 as an exemplary non-limiting embodiment of method 200A. Moreover, method 200A can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2A, as will be understood by a person of ordinary skill in the art(s).

At step 202, document upload application 112 installed in user equipment 110 captures document images of a document to be uploaded to backend system 120. In some embodiments, document upload application 112 may be configured with a parameter indicating the number of document images to be captured of the document to be uploaded. For example, the graphical user interface provided by document upload application 112 may be configured to require capturing both a front image of the document and a back image of the document. In some embodiments, the document upload application 112 may be configured to utilize a video function to capture multiple frames of the document, such as multiple frames of the front of the document and multiple frames of the back of the document. Document upload application 112 may receive a request to electronically initiate and perform the document upload process.

At step 204, document upload application 112 transmits the document images (or multiple frames) to backend system 120, which may cache the received images (or frames) in a temporary storage location such as an S3 bucket implemented with cache control. Backend system 120 may configure the cache to store document images for a predetermined period of time, such as for the duration of the upload process, before they are erased.

At step 206, document upload application 112 transmits an OCR request to backend system 120 to perform OCR on the document images uploaded so that OCR may be performed during the document upload procedure. In some embodiments, the OCR request may be implemented as a request tag that is incorporated into one or more of the document images transmitted by document upload application 112 as part of step 204. For example, document upload application 112 may modify the front image of a check or the back image of the check to include the request tag before transmitting the front image or the back image to the backend system. In embodiments, the request tag may only be included in one of the document images. In other embodiments, the OCR request may be implemented as a separate API call transmitted by document upload application 112 after determining that all images of the document have been captured. In some embodiments, the request tag may be included with a frame within a set of frames representing the document.

At step 208, backend system 120 performs OCR on the document images to detect contents of the document after receiving the OCR request from document upload application 112. For example, OCR component 124 may detect a monetary amount specified in a check, a routing number associated with the issuing bank, and/or other account information specified on the document. In embodiments, the detected contents are needed to determine a risk associated with uploading the document to the user account including updating the user account based on the contents of the document. In embodiments, the risk may be used to determine whether to approve the document upload when an exception or error is detected with the upload. As noted, one example of an exception is that the monetary amount in the check is greater than a threshold amount associated with the user and/or the user's account (where the check is being deposited). The risk may reflect a confidence score for either allowing the upload process to proceed despite the exception, or terminating the process. In embodiments where the backend system 120 receives multiple frames from document upload application 112 (as part of a video capture of the document), OCR component 124 may use frames of the front of the document to verify the data on the front of the document, such as by detecting the same information in one or more of the frames and performing a comparison of the detected information. For example, OCR component 124 may detect the account number in each frame of the front of a check or the user name in each frame of an application and determine whether the detected information is the same across the frames. OCR component 124 may perform a similar process for each set of frames the represent different portions of the document, such as the second page or the back page of the document.

At step 210A, error assessment module 126 of backend system 120 determines an exception has occurred while uploading the document to the user account. In embodiments, this exception relates to whether the monetary amount specified by the check is above a threshold amount, i.e., whether the amount is above a deposit limit associated with the user and/or the user account. In some embodiments, the deposit limit, or the threshold amount, may be determined on a user-specific basis prior to the upload process and stored in a memory of the backend system 120. In some embodiments, the deposit limit may be determined or updated (if previously determined) dynamically during the upload process. In additional embodiments, the deposit limit may be a global limit that applies to all or a subset of users of backend system 120.

At step 212A, if error assessment module 126 does not detect any exceptions, then the upload process may proceed as normal and the document may be uploaded to backend system 120. For example, the check may be deposited into the user's account.

At step 214A, if error assessment module 126 does detect an exception, such as an exception related to the monetary amount specified in the document, error assessment module 126 may trigger the limits model 128 to determine whether to proceed with the upload process, i.e., approve a limit increase. The limits model 128 may receive, as input, content information detected by OCR component 124, such as the monetary value and routing numbers, as well as information associated with the user account such as account history and transaction history. The account history and transaction history are associated with the user account (where the document is being uploaded) and may be retrieved from a database connected to backend system 120. In some embodiments, the output of the error assessment module 126 is a risk assessment based on the provided inputs. In some embodiments, the risk assessment includes a confidence score or a value that can be compared to a threshold value. For example, the confidence score may represent a ranking of the received inputs compared to the training data that was used to train limits model 128.

At step 216A, error assessment module 126 determines whether the upload is approved based on the risk assessment determined at step 214A. For example, error assessment module 126 may compare a confidence score with a threshold value and may allow the upload to proceed at step 212A, if the confidence score is above the threshold value.

At step 218A, error assessment module 126 may decline the upload if it determines that the confidence score is below the threshold value which results in terminating the upload process. Backend system 120 may cancel the document upload process including purging the document images from image database 122.

FIG. 2B is an example method 200B of handling errors associated with the document images uploaded to backend system 120. As a non-limiting example with regards to FIG. 1, one or more processes described with respect to FIG. 2B may be performed by one or more devices of environment 100. In such an embodiment, the one or more devices of environment 100 may execute code in memory to perform certain steps of method 200B. While method 200B of FIG. 2B will be discussed below as being performed by one or more components of environment 100, other devices not shown may store the code and therefore may execute method 200B by directly executing the code. Accordingly, the following discussion of method 200B will refer to devices of FIG. 1 as an exemplary non-limiting embodiment of method 200B. Moreover, method 200B can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2B, as will be understood by a person of ordinary skill in the art(s).

Steps 202-208 are performed similarly to those described above with respect to FIG. 2A.

At step 210B, error assessment module 126 of backend system 120 determines there is an irregularity with the document being uploaded, where the irregularity is based on one or more rules established by OCR component 124. In some embodiments, this determination may be based on OCR component 124 detecting the irregularity in the document image. Examples of errors or irregularities with the document include unreadable portions of the document image and non-standard formatting for the document, such as missing account information. Examples of an unreadable portion may include blurry or otherwise undetectable portions of the document image that cannot be read by OCR component 124. Examples of non-standard formatting may include absent/missing document characteristics such as routing or account numbers or other information that are expected to be in the document. Such characteristics may not necessarily indicate that the document is fraudulent such as state-issued checks that lack an account number but that are still legitimate documents. OCR rules may not necessarily be capable of detecting non-standard but still legitimate documents. Accordingly, a secondary review of such documents may be necessary to approve uploading the document to backend system 120.

The error assessment module 126 may receive, as an input, detected contents from the OCR and a result of comparing the detected contents to formatting rules of documents to be uploaded to the backend system 120. In this embodiment, the output of the error assessment module 126 is an indication whether an irregularity exists in the document.

At step 212B, error assessment module 126 determines that an irregularity does not exist and proceeds normally with the upload process.

At step 214B, error assessment module 126 determines that an irregularity exists and sends a prompt to document upload application 112 whether to trigger a secondary review process on the document image to resolve the detected irregularity. The prompt may include a description of the irregularity and/or an annotated image of the irregularity. The user may then decide, based on the provided information, to end the upload process and start a new upload process to retake new images of the document. For example, the prompt may show a portion of the document that is obstructed by the user's finger which would indicate that the images need to be retaken. In some embodiments, document upload application 112 may be bypassed and the secondary review may be automatically triggered based on certain conditions associated with the irregularity. For example, the type of irregularity, such as certain missing expected information from the document, may require secondary review because the irregularity is not correctible by the user to determine whether missing information is fatal to the upload process. For example, certain state-issued checks lack account numbers and a secondary review may be necessary to verify the authenticity of such documents. Backend system 120 may detect the type of irregularity and determine whether to automatically trigger the secondary review without transmitting the prompt to the document upload application 112. In some embodiments, the secondary review process may be performed by backend system 120, such as a manual review by an agent.

At step 216B, if document upload application 112 receives input not to trigger the secondary review process, the document upload application 112 then terminates the document upload process.

At step 218B, if document upload application 112 receives input to trigger the secondary review process by backend system 120, document upload application 112 transmits a command to backend system 120 which initiates the secondary review process by routing the document images to an agent. In some embodiments, the review may be performed by the agent at backend system 120. In some embodiments, the agent is a person who manually reviews the document images and provides approval to backend system based on the manual review. In some embodiments, the agent is an automated bot that may perform a second OCR process on the document images to determine whether the irregularity exists in the second review. If the secondary review process results in approving the document for uploading, then the upload process continues at step 212B.

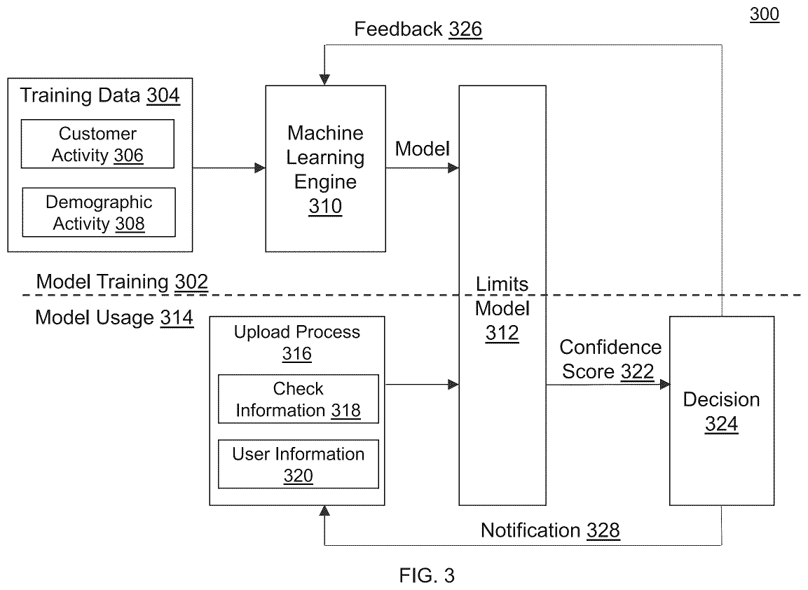

FIG. 3 is a block diagram of a machine learning system that includes model training 302 for training a limits model and model usage 314 for using the limits model during an upload process, according to some embodiments. The machine learning system is a framework that trains limits model 128.

Model training 302 includes using training data 304 to train a machine learning engine 310 for outputting limits model 312. Machine learning engine 310 may comprise one or more servers (cloud or local) for processing text, such as words, phrases or sentences, to recognize relationships of the words (e.g., within sentences) of training data 304. For example, training data 304 may include customer activity 306 and demographic activity 308 which may be provided as structured data (e.g., using known control constructs). Machine learning involves computers discovering how they can perform tasks without being explicitly programmed to do so. Machine learning (ML) includes, but is not limited to, artificial intelligence, deep learning, fuzzy learning, supervised learning, unsupervised learning, etc. Machine learning engine 310 builds limits model 312 based on training data 304 in order to make predictions or decisions based on new data. For supervised learning, the computer is presented with training data 304 and a desired output (such as the amount of risk associated with the training data 304), and the goal is to learn a general rule that maps the training data 304 to the desired output. In another example, for unsupervised learning, no labels are given to machine learning engine 310, and machine learning engine 310 finds structure in the training data 304. Unsupervised learning can be a goal in itself (discovering hidden patterns in data) or a means towards an end (feature learning). Machine learning engine 310 may use various classifiers to map concepts associated with a specific language structure to capture relationships between concepts and words/phrases/sentences.

Training data 304 may comprise customer activity 306 and demographic activity 308. Customer activity 306 may comprise historical customer data related to prior document upload requests. This data may include information about the documents being uploaded and the results of the upload (e.g., whether the document was determined to be fraudulent, whether the document upload failed). In some embodiments, the prior document upload requests are correlated based on the upload type. For example, upload types may include uploading a check that included a check amount that was over a preset threshold and uploading an non-standard document that lacked expected document information. Demographic activity 308 may comprise data associated with check amounts, customers, and different document vendors. For example, demographic data for check amounts may include data regarding documents having similar check amounts (e.g., checks that are $10 over the preset threshold, checks that are $50 over the preset threshold, checks that are $100 over the preset threshold). Demographic data for customers may include data regarding similar customers (e.g., customers in the same age group, customer having similar bank account activity). Demographic data for document vendors may include data regarding vendors such as their reputation.

Training data 304 may comprise hundreds or thousands of freeform document-related activity that were previously uploaded to backend system 120. The underlying model methodology may leverage any of GMMHMM (Gaussian mixture modeling and hidden Markov modeling), Ngram language modeling, and deep neural networks (DNN). Lower error rates may be achieved by continuous training and fine-tuning of the model such as using feedback 326 as a result of a decision 324 made by limits model 312. In other words, the output of a current decision may be used to further train limits model 312. In some embodiments, machine learning engine 310 is supervised in that, based on customer activity 306 and demographic activity 308, an output control is correlated to the input data. For example, “a check that was $50 over a preset deposit threshold from a customer having specific pattern of activity and from XYZ issuing bank” is provided with a corresponding answer of a known previous control, such as an unsuccessful deposit. This process is repeated for hundreds or thousands controls. While described in an exemplary embodiment for supervised learning, unsupervised learning may be substituted without departing from the scope of the technology described herein.

In one embodiment, once limits model 312 is trained, it may be used for subsequent uploads to determine whether to approve or deny subsequent uploads that involve check amounts that are above preset thresholds. Model usage 314 may include an upload process 316 that results in sending check information 318 and user information 320 to backend system 120 where it is fed as inputs to limits model 312. Check information 318 includes information from the document being uploaded and detected by OCR component 124, such as an account number, a routing number, and a check amount. User information 320 includes information about the user requesting the upload and may include information about user such as user tenure (e.g., how long the user has been a customer of backend system 120), user activity (e.g., previous requests involving documents over the preset threshold), and user reputation (e.g., is the user's account in good standing, has the user's account previously been in bad standing).

This information is provided to limits model 312 which generates confidence score 322 based on the provided inputs. In some embodiments, confidence score 322 may reflect a ranking of the provided inputs relative to training data 304 where the higher the ranking, the higher the confidence that the requested upload, based on the provided inputs, will be successful and presents minimal risk to backend system 120. A lower ranking may indicate a lower confidence and that the requested upload presents a greater risk to the backend system 120. In some embodiments, confidence score 322 may be represented as a numerical value generated by limits model 312 based on the provided inputs.

Limits model 312 may use the confidence score 322 to make decision 324 regarding whether to allow the upload to proceed. In some embodiments, decision 324 is based on comparing the confidence score 322 to a preset threshold, which may be generated on a user-specific or global basis. A user-specific threshold may be associated with each user who requests a document upload and each time the user requests an upload, the monetary amount (if applicable) specified by the document is compared with the user-specific threshold. The user-specific threshold may be generated based on similar inputs that are received by the limits model 312 such as user information 320 which takes into account the user's past history, reputation, and user's account information. For example, a user with a reputation of maintaining an average balance above a certain amount (e.g., $10,000) may have a higher preset threshold than a user maintains an average balance below that certain amount. Accordingly, different users may receive different preset thresholds. In some embodiments, limits model 312 may utilize a global threshold that applies to all users accessing backend system 120.

Decision 324 may be used as feedback 326 for machine learning engine 310 and as notification 328 for upload process 316. Feedback 326 may be used to further train or refine training of limits model 312 to improve the accuracy and reliability of confidence scores generated by limits model 312. Feedback 326 may include information about the decision (e.g., whether the upload request was approved), about the document (e.g., monetary amount, routing number, account number), about the user account to which the document was being uploaded (e.g., threshold for the monetary amount, the difference between the monetary amount detected in the document and the threshold), and the results of the decision 324 (e.g., whether the uploaded document was later declined).

Notification 328 is provided back to upload process 316 to be displayed by document upload application 112. Notification 328 displays the result of the decision 324, i.e., whether the upload request was denied or granted, and may include additional information such as the difference between the monetary amount and the threshold and other reasons for decision 324.

### Components of the System

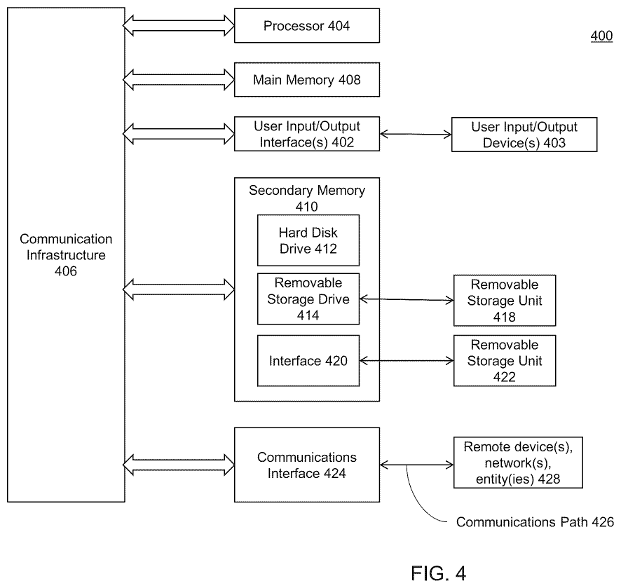

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The terms “module” or “unit” referred to in this disclosure can include software, hardware, or a combination thereof in an aspect of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

The above detailed description and aspects of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

These and other valuable aspects of the aspects of the present disclosure consequently further the state of the technology to at least the next level. While the disclosed aspects have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A system for providing exception handling during a document upload process of a document, comprising:
a memory; and
at least one processor coupled to the memory and configured to:
receive, from an upload application on a user device, a front image of the document and a back image of the document request to be uploaded to a user account maintained by the system;
detect, based on performing an instant optical character recognition (OCR) of at least one of the front image of the document and the back image of the document, content of the document; and
initiate the exception handling based on the content of the document being greater than a preset threshold amount, wherein the exception handling comprises:
sending the content of the document and the user information associated with the user device to a limits model;
receiving, from the limits model, a confidence score based on the content of the document; and
determining whether to allow the document upload process to proceed based on the confidence score being greater than a second preset threshold amount.

2. The system of claim 1, wherein the content of the document comprises a monetary amount to be uploaded into the user account.

3. The system of claim 2, wherein the user information associated with the user device comprises a user transaction history for the user account.

4. The system of claim 3, wherein the confidence score is generated based on the user transaction history for the user account, the monetary amount, and the preset threshold amount.

5. The system of claim 2, wherein the processor is further configured to:
determine a difference between the monetary amount to be uploaded into the user account to the preset threshold amount; and
providing the difference to the limits model.

6. The system of claim 1, wherein the preset threshold amount is a monetary upload limit associated with the user account.

7. The system of claim 1, wherein the document is a check.

8. The system of claim 1, wherein the user account is a checking account.

9. The system of claim 1, wherein the processor is further configured to:
providing training data to a machine learning engine for training the limits model.

10. The system of claim 9, wherein the training data comprises user activity and demographic activity.

11. A non-transitory computer-readable medium storing instructions for providing exception handling during a document upload process of a document, when executed by a processor on a mobile device, cause the processor to perform operations comprising:
receiving, from an upload application on a user device, a front image of the document and a back image of the document request to be uploaded to a user account;
detecting, based on performing an instant optical character recognition (OCR) of at least one of the front image of the document and the back image of the document, content of the document; and
initiating the exception handling based on the content of the document being greater than a preset threshold amount, wherein the exception handling comprises:
sending the content of the document and the user information associated with the user device to a limits model;
receiving, from the limits model, a confidence score based on the content of the document; and
determining whether to allow the document upload process to proceed based on the confidence score being greater than a second preset threshold amount

[symbol]

12. The non-transitory computer-readable medium of claim 11, wherein the content of the document comprises a monetary amount to be uploaded into the user account.

13. The non-transitory computer-readable medium of claim 12, wherein the user information associated with the user device comprises a user transaction history for the user account.

14. The non-transitory computer-readable medium of claim 13, wherein the confidence score is generated based on the user transaction history for the user account, the monetary amount, and the preset threshold amount.

15. The non-transitory computer-readable medium of claim 11, wherein the preset threshold amount is a monetary upload limit associated with the user account.

16. The non-transitory computer-readable medium of claim 11, wherein the user account is a checking account.

17. A computer implemented method for providing exception handling during a document upload process of a document, the method comprising:
receiving, from an upload application on a user device, a front image of the document and a back image of the document request to be uploaded to a user account;
detecting, based on performing an instant optical character recognition (OCR) of at least one of the front image of the document and the back image of the document, content of the document; and
initiating the exception handling based on the content of the document being greater than a preset threshold amount, wherein the exception handling comprises:
sending the content of the document and the user information associated with the user device to a limits model;
receiving, from the limits model, a confidence score based on the content of the document; and
determining whether to allow the document upload process to proceed based on the confidence score being greater than a second preset threshold amount.

18. The method of claim 17, wherein the content of the document comprises a monetary amount to be uploaded into the user account.

19. The method of claim 18, wherein the user information associated with the user device comprises a user transaction history for the user account.

20. The method of claim 19, wherein the confidence score is generated based on the user transaction history for the user account, the monetary amount, and the preset threshold amount.
